(19) United States
(12) Patent Application Publication
(10) Pub. No.: US 2024/0119354 A1
(43) Pub. Date: Apr. 11, 2024

(54) MODEL TRAINING METHOD AND MODEL TRAINING SYSTEM

(71) Applicant: TOYOTA JIDOSHA KABUSHIKI KAISHA, Toyota-shi Aichi-ken (JP)

(72) Inventors: Hsuan-Kung YANG, Minato-ku Tokyo (JP); Norimasa Kobori, Nerima-ku Tokyo (JP)

(73) Assignee: TOYOTA JIDOSHA KABUSHIKI KAISHA, Toyota-shi Aichi-ken (JP)

(21) Appl. No.: 18/233,447

(22) Filed: Aug. 14, 2023

(30) Foreign Application Priority Data
Oct. 7, 2022 (JP) 2022-162349

(51) Int. Cl. G06N 20/00

(52) U.S. Cl. CPC G06N 20/00

(57) ABSTRACT

A model training method trains an object identification model that is based on machine learning. The model training method includes acquiring labeled training data where a track is given as a label to a sequence of images. The track is information representing a time series of a same moving object in the sequence of images and is automatically obtained by a tracker that tracks the same moving object in the sequence of images. The model training method further includes training the object identification model based on the labeled training data.

### CROSS-REFERENCES TO RELATED APPLICATION

The present disclosure claims priority to Japanese Patent Application No. 2022-162349, filed on Oct. 7, 2022, the contents of which application are incorporated herein by reference in their entirety.

### TECHNICAL FIELD

The present disclosure relates to an object identification model that is based on machine learning.

### BACKGROUND ART

Patent Literature 1 (WO2021/260899) discloses a tracking device that tracks an object (e.g., human) by using a recognition model. The recognition model extracts an object from an image captured by a surveillance camera. The recognition model then extracts feature amounts of the extracted object to track the extracted object.

Non-Patent Literature 1 discloses a tracker called “ByteTrack.”

### LIST OF RELATED ART

Patent Literature 1: International Publication WO2021/260899
Non-Patent Literature 1: Zhang et al., “ByteTrack: Multi-Object Tracking by Associating Every Detection Box,” arXiv:2110.06864v3 [cs.CV], April 2022 (https://arxiv.org/abs/2110.06864)

### SUMMARY

An object identification model based on machine learning is used for identifying an object in an image. In order to achieve an object identification model, it is required to train the object identification model by using a sufficient amount of labeled training data. However, data labeling (annotating) is in general time-consuming and labor-intensive and thus expensive.

A first aspect of the present disclosure is directed to a model training method for training an object identification model that is based on machine learning.

The model training method includes: acquiring labeled training data where a track is given as a label to a sequence of images.

The track is information representing a time series of a same moving object in the sequence of images and is automatically obtained by a tracker that tracks the same moving object in the sequence of images.

The model training method further includes: training the object identification model based on the labeled training data.

A second aspect of the present disclosure is directed to a model training system that trains an object identification model that is based on machine learning.

The model training system includes one or more processors.

The one or more processors acquire labeled training data where a track is given as a label to a sequence of images.

The track is information representing a time series of a same moving object in the sequence of images and is automatically obtained by a tracker that tracks the same moving object in the sequence of images.

The one or more processors train the object identification model based on the labeled training data.

According to the present disclosure, the track is used as the label in the labeled training data. The track can be automatically obtained by tracking the same moving object in the sequence of images. It is therefore possible to greatly reduce the human work in data labeling (annotating), that is, in generating the labeled training data. As a result, time and cost can be greatly saved.

Furthermore, since the labeled training data can be acquired in a time and cost saving manner, it is possible to quickly train the object identification model by using a sufficient amount of labeled training data. That is, it is possible to efficiently and effectively train the object identification model. As a result, the object identification model is further optimized.

### BRIEF DESCRIPTION OF DRAWINGS

FIG. 1 is a conceptual diagram for explaining an object identification model according to an embodiment of the present disclosure;

FIG. 2 is a block diagram showing an example of a system configuration according to an embodiment of the present disclosure;

FIG. 3 is a conceptual diagram for explaining a track;

FIG. 4 is a conceptual diagram for explaining labeled training data according to an embodiment of the present disclosure;

FIG. 5 is a block diagram showing a configuration example of a training data generation system according to an embodiment of the present disclosure;

FIG. 6 is a block diagram showing a first example of a functional configuration of a training data generation system according to an embodiment of the present disclosure;

FIG. 7 is a conceptual diagram for explaining a track integration process according to an embodiment of the present disclosure;

FIG. 8 is a conceptual diagram for explaining a track integration process according to an embodiment of the present disclosure;

FIG. 9 is a block diagram showing a second example of a functional configuration of a training data generation system according to an embodiment of the present disclosure;

FIG. 10 is a block diagram showing a third example of a functional configuration of a training data generation system according to an embodiment of the present disclosure;

FIG. 11 is a block diagram showing a configuration example of a model training system according to an embodiment of the present disclosure;

FIG. 12 is a block diagram showing a first example of a functional configuration of a model training system according to an embodiment of the present disclosure; and

FIG. 13 is a block diagram showing a second example of a functional configuration of a model training system according to an embodiment of the present disclosure.

### DETAILED DESCRIPTION

Embodiments of the present disclosure will be described with reference to the attached drawings.

### 1. Outline

### 1-1. Object Identification Model

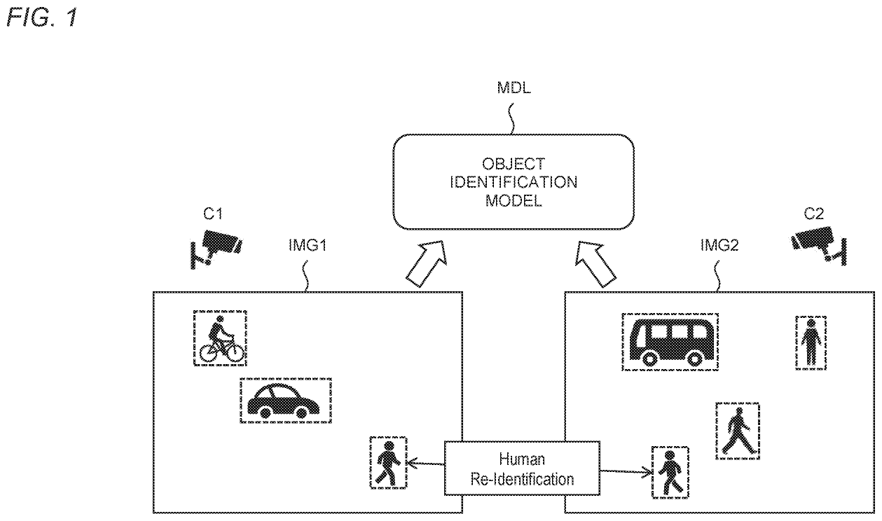

FIG. 1 is a conceptual diagram for explaining an object identification model MDL according to the present embodiment. The object identification model MDL is used for identifying an object in an image. Typically, the object to be identified by the object identification model MDL is a moving object. Examples of the moving object include a human (pedestrian), a vehicle, a motor cycle, a bicycle, a robot, and the like.

The object identification model MDL is based on machine learning. For example, the object identification model MDL is based Transformer, a kind of deep learning model. As another example, the object identification model MDL may be based on CNN (Convolutional Neural Network).

Typically, the object identification model MDL performs feature extraction to identify the object. That is, the object identification model MDL extracts a feature amount of the object detected in the image and identifies the object based on the extracted feature amount.

The object identification model MDL may identify the same object in different images captured by two or more different cameras. In that case, it is possible to chase the same moving object across the two or more different cameras. In the example shown in FIG. 1, an image IMG1 is captured by a camera C1, and another image image IMG2 is captured by another camera C2. The object identification model MDL identifies (re-identifies) the same pedestrian in the two different images IMG1 and IMG2. Such the object identification model MDL is also called a “human re-identification model” or a “person re-identification model.” The object identification model MDL may be a transformer-based human re-identification model.

In order to achieve an object identification model MDL, it is required to train the object identification model MDL by using a sufficient amount of labeled training data. However, data labeling (annotating) is in general time-consuming and labor-intensive and thus expensive.

In view of the above, the present disclosure provides a technique that can reduce human work in the data labeling (annotating), that is, in generating labeled training data. The present disclosure further provides a technique that can train the object identification model MDL by using a sufficient amount of labeled training data.

### 1-2. System Configuration

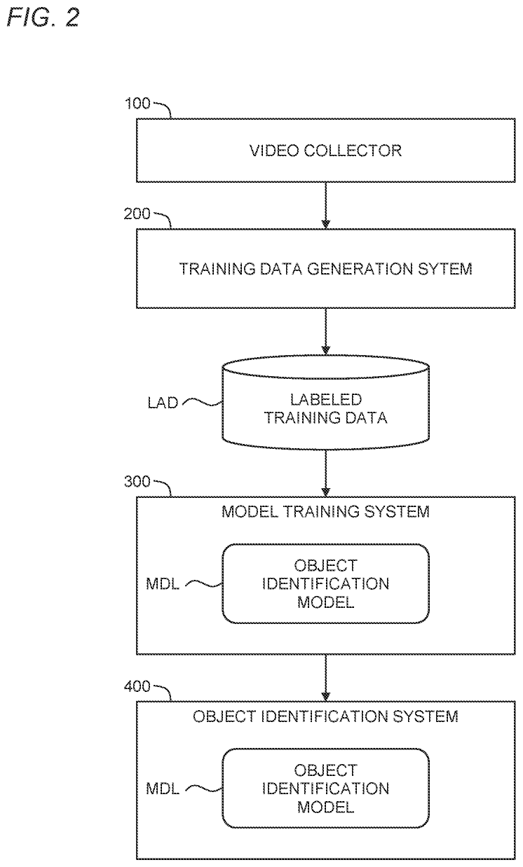

FIG. 2 is a block diagram showing an example of a system configuration according to the present embodiment. The system according to the present embodiment includes a video collector 100, a training data generation system 200, a model training system 300, and an object identification system 400.

The video collector 100 collects videos. For example, the video collector 100 communicates with at least one camera to collect videos captured by the at least one camera. The at least one camera is installed in a city, a building, and the like. As another example, the video collector 100 may collect videos from a video posting site. The video collector 100 supplies the collected video data to the training data generation system 200.

The training data generation system 200 receives the video data from the video collector 100. The training data generation system 200 automatically or almost automatically generates labeled training data LAD based on the video data. The labeled training data LAD are training data in which labels are respectively given to objects in the image. The labeled training data LAD are also called annotated training data. Details of generation of the labeled training data LAD will be described later.

The model training system 300 acquires the labeled training data LAD generated by the training data generation system 200. The model training system 300 trains the object identification model MDL based on the labeled training data LAD. In other words, the model training system 300 trains the object identification model MDL by using the labeled training data LAD. Here, a “supervised learning” or a “semi-supervised learning” is used for training the object identification model MDL.

The object identification system 400 acquires the object identification model MDL trained by the model training system 300. The object identification system 400 performs an object identification process by utilizing the object identification model MDL. More specifically, the object identification system 400 acquires video data, and identifies objects in the video data by inputting the video data to the object identification model MDL.

The training data generation system 200, the model training system 300, and the object identification system 400 may be distributed systems. That is, the training data generation system 200, the model training system 300, and the object identification system 400 may be constructed on different nodes (computers) that communicate with each other. As another example, some of the training data generation system 200, the model training system 300, and the object identification system 400 may be constructed on a single node (computer).

### 1-3. Track Used as Label

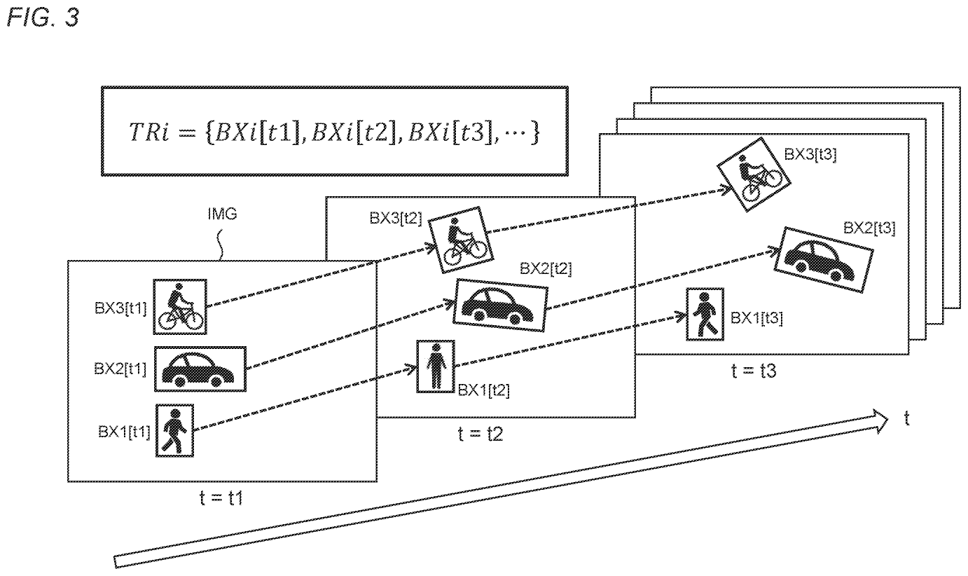

FIG. 3 is a conceptual diagram for explaining a “track.” A sequence of images IMG at different time steps (t=t1, t2, t3, . . . ) included in a video are shown in FIG. 3. Each image IMG shows at least one moving object. Examples of the moving object include a human (pedestrian), a vehicle, a motor cycle, a bicycle, a robot, and the like.

The training data generation system 200 detects the moving object in the sequence of images IMG included in the video. A bounding box BX represents a location of the detected moving object in the image IMG. The training data generation system 200 acquires information of the bounding box BX of each moving object in the sequence of images IMG.

In conjunction with a movement of a moving object, the bounding box BX representing the moving object moves in the sequence of images IMG. Multiple bounding boxes BX representing a same moving object in the sequence of images IMG at different time steps are spatially continuous. Therefore, paying attention to the movement of the bounding box BX makes it possible to identify the multiple bounding boxes BX representing the same moving object in the sequence of images IMG. For example, in FIG. 3, multiple bounding boxes BX1[t] (t=t1, t2, t3, . . . ) in the sequence of images IMG at different time steps represent a same pedestrian. Multiple bounding boxes BX2[t] (t=t1, t2, t3, . . . ) in the sequence of images IMG at different time steps represent a same vehicle. Identifying the multiple bounding boxes BX representing the same moving object in the sequence of images IMG makes it possible to track the same moving object in the sequence of images IMG.

A “tracker” is software that automatically tracks the same moving object in the sequence of images IMG based on a tracking algorithm. For example, “ByteTrack” is known as a strong tracker (see the above Non-Patent Literature 1).

The tracker (i.e., the tracking algorithm) tracks the same moving object in the sequence of images IMG based on the movement of the bounding box BX. More specifically, the tracker tracks the same moving object in the sequence of images IMG by identifying the multiple bounding boxes BXi[t] (t=t1, t2, t3 . . . ) representing the same moving object in the sequence of images IMG. Here, i (=1, 2, 3, . . . ) is an identifier of the multiple bounding boxes BX representing the same moving object. The tracker associates the multiple bounding boxes BXi[t] representing the same moving object in the sequence of images IMG at different time steps with each other. It should be noted here that the tracker does not need feature extraction to track the same moving object. The tracker tracks the same moving object based on the movement of the bounding box BX, without performing the feature extraction.

A “track TRi” is information representing a time series of the same moving object in the sequence of images IMG. More specifically, the track TRi is identification information indicating the multiple bounding boxes BXi[t] representing the same moving object in the sequence of images IMG at different time steps. It should be noted here that the track TRi is not identification information of the moving object itself. For example, the track TRi does not indicate who the pedestrian is. At this stage, there is no need to know who the pedestrian is.

As described above, the track TRi can be automatically acquired by the tracker that tracks the same moving object in the sequence of images IMG. According to the present embodiment, such the track TRi is uses as a label in the labeled training data LAD.

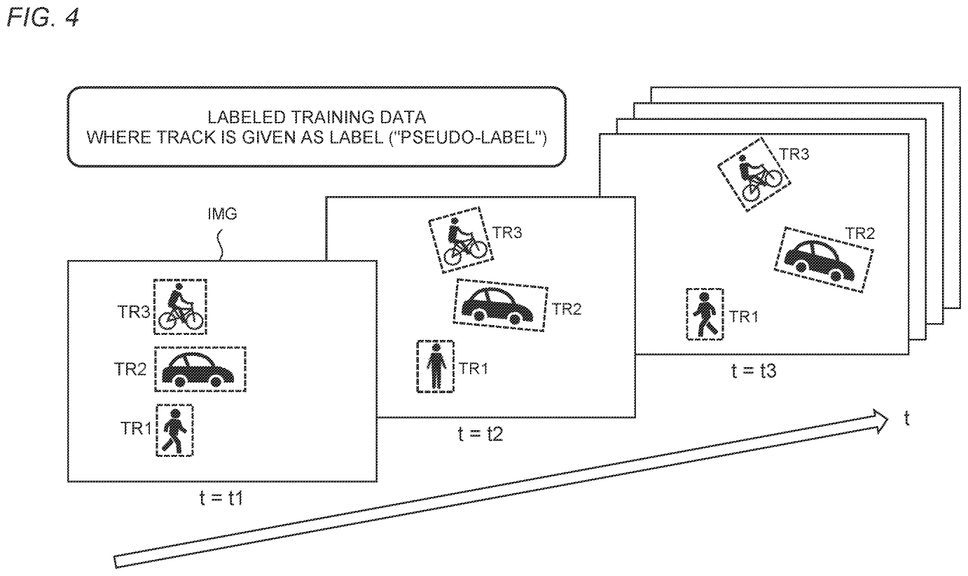

FIG. 4 is a conceptual diagram for explaining the labeled training data LAD according to the present embodiment. The track TRi is given as a label to the sequence of images IMG included in the video. The track TRi may be called a “pseudo label.” The sequence of images IMG to which the track TRi is given as the label are the labeled training data LAD.

The training data generation system 200 uses the tracker to track the same moving object in the sequence of images IMG. In other words, the training data generation system 200 tracks the same moving object in the sequence of images IMG based on the tracking algorithm. Thus, the training data generation system 200 is able to automatically obtain the track TRi that is information representing the time series of the same moving object in the sequence of images IMG. The training data generation system 200 generates the labeled training data LAD by giving the track TRi as the label to the sequence of images IMG.

### 1-4. Effects

According to the present embodiment, as described above, the track TRi is used as the label in the labeled training data LAD. The track TRi can be automatically obtained by tracking the same moving object in the sequence of images IMG. It is therefore possible to greatly reduce the human work in the data labeling (annotating), that is, in generating the labeled training data LAD. As a result, time and cost can be greatly saved.

Furthermore, since the labeled training data LAD can be acquired in a time and cost saving manner, it is possible to quickly train the object identification model MDL by using a sufficient amount of labeled training data LAD. That is, it is possible to efficiently and effectively train the object identification model MDL. As a result, the object identification model MDL is further optimized. For example, it is possible to make the object identification model MDL keep up-to-date with circumstances (e.g. regions, seasons). In other words, it is possible to optimize (fine tune) the object identification model MDL in consideration of the latest circumstances.

Hereinafter, concrete examples of the training data generation system 200 and the model training system 300 will be described.

### 2. Training Data Generation System

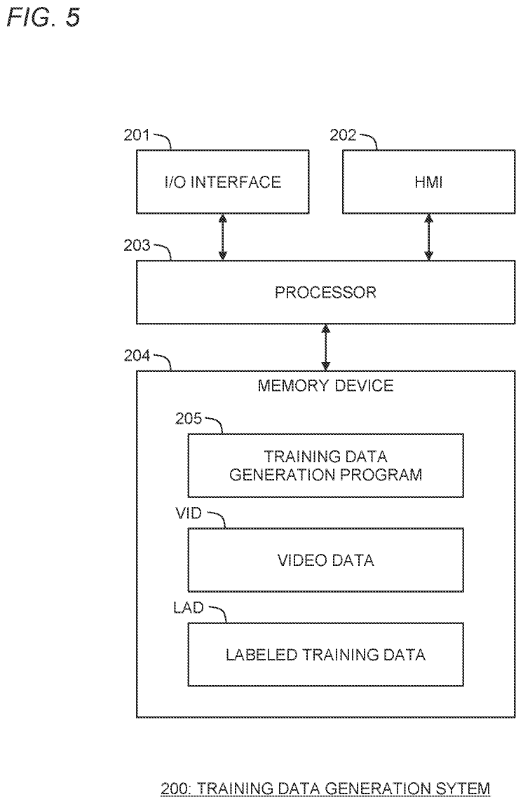

FIG. 5 is a block diagram showing a configuration example of the training data generation system 200 according to the present embodiment. The training data generation system 200 includes an I/O (Input/Output) interface 201, an HMI (Human Machine Interface) 202, one or more processors 203 (hereinafter simply referred to as a processor 203), and one or more memory devices 204 (hereinafter simply referred to as a memory device 204).

The I/O interface 201 receives a variety of data from the outside and outputs a variety of data to the outside. For example, the I/O interface 201 includes a network interface controller (NIC).

The HMI 202 is an interface for providing information to a user and receiving information from the user. More specifically, the HMI 202 includes an input device and an output device. Examples of the input device include a touch panel, a key board, and the like. Examples of the output device include a display, and the like.

The processor 203 executes a variety of processing. For example, the processor 203 includes a CPU (Central Processing Unit). The memory device 204 stores a variety of information necessary for the processing. Examples of the memory device 204 include a volatile memory, a non-volatile memory, an HDD (Hard Disk Drive), an SSD (Solid State Drive), and the like.

The processor 203 executes a training data generation process. In the training data generation process, the processor 203 acquires video data VID from the video collector 100 via the I/O interface 201. The video data VID are stored in the memory device 204. The processor 203 automatically or almost automatically generates the labeled training data LAD based on the video data VID. The labeled training data LAD are stored in the memory device 204. Moreover, the processor 203 outputs the labeled training data LAD to the model training system 300 (see FIG. 2) via the I/O interface 201.

A training data generation program 205 is a computer program executed by the processor 203 to perform the training data generation process. The training data generation program 205 is stored in the memory device 204. The training data generation program 205 may be recorded on a non-transitory computer-readable recording medium. The training data generation program 205 may be provided via a network. The training data generation process is achieved by a cooperation of the processor 203 executing the training data generation program 205 and the memory device 204.

Hereinafter, several examples of the training data generation process will be described.

### 2-1. First Example

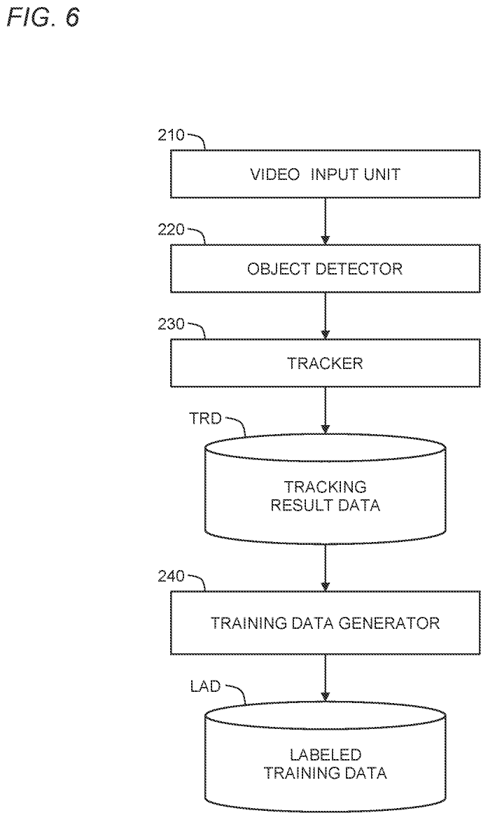

FIG. 6 is a block diagram showing a first example of a functional configuration of the training data generation system 200. The training data generation system 200 includes, as functional blocks, a video input unit 210, an object detector 220, a tracker 230, and a training data generator 240.

The video input unit 210 acquires the video data VID via the I/O interface 201 or from the memory device 204. The video data VID includes a sequence of images IMG.

The object detector 220 detects a moving object in the sequence of images IMG. For example, YOLOX is utilized as the object detector 220. The bounding box BX represents a location of the detected moving object in the image IMG. The object detector 220 acquires information of the bounding box BX of each moving object in the sequence of images IMG.

The tracker 230 automatically tracks the same moving object in the sequence of images IMG based on a tracking algorithm. For example, ByteTrack (see the above Non-Patent Literature 1) is utilized as the tracker 230. The tracker 230 tracks the same moving object in the sequence of images IMG based on the movement of the bounding box BX, without performing the feature extraction. More specifically, the tracker 230 tracks the same moving object in the sequence of images IMG by identifying the multiple bounding boxes BXi[t] (t=t1, t2, t3 . . . ) representing the same moving object in the sequence of images IMG. The tracker 230 associates the multiple bounding boxes BXi[t] representing the same moving object in the sequence of images IMG with each other.

The track TRi is identification information indicating the multiple bounding boxes BXi[t] representing the same moving object in the sequence of images IMG at different time steps. In other words, the track TRi is information representing a time series of the same moving object in the sequence of images IMG. Tracking result data TRD indicate the tracks TRi in the sequence of images IMG. The tracker 230 automatically tracks the same moving object to generate the tracking result data TRD.

The training data generator 240 automatically generates the labeled training data LAD based on the sequence of images IMG and the tracking result data TRD. More specifically, the training data generator 240 gives the track TRi as the label to the sequence of images IMG to generate the labeled training data LAD.

### 2-2. Second Example

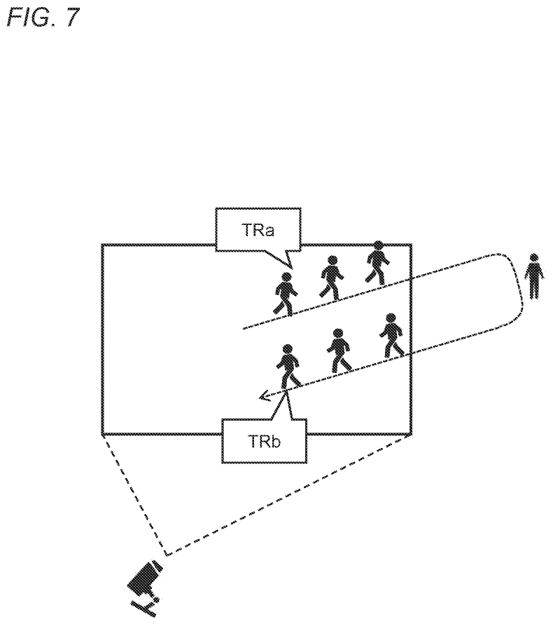

There is a possibility that two or more different tracks TRi are given to the same moving object. For example, FIG. 7 shows a situation where a certain moving object goes out of a field of view of a camera and then re-enters the field of view of the same camera. As a result, two different tracks TRa and TRb may be given to the same moving object. Such the two or more different tracks TRi given to the same moving object are hereinafter referred to as “overlapping tracks.”

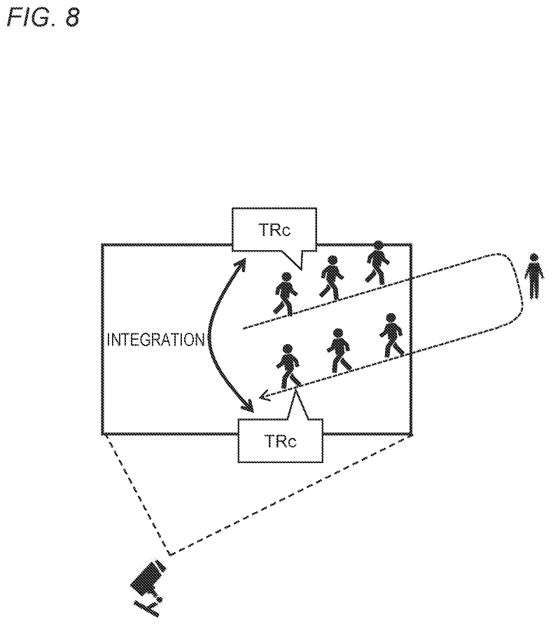

Occurrence of the overlapping tracks means that two or more different labels are given to the same moving object in the labeled training data LAD. If two or more different labels are given to the same moving object in the labeled training data LAD, accuracy of the model training may be deteriorated. It is therefore desirable to detect the overlapping tracks and to integrate the overlapping tracks into a single unified track. For example, the overlapping tracks TRa and TRb shown in FIG. 7 are integrated into a single unified track TRc as shown in FIG. 8.

However, manually detecting and integrating the overlapping tracks require human effort and time-consuming. In view of the above, the training data generation system 200 may be configured to automatically detect and integrate the overlapping tracks. This process is hereinafter referred to as a “track integration process.”

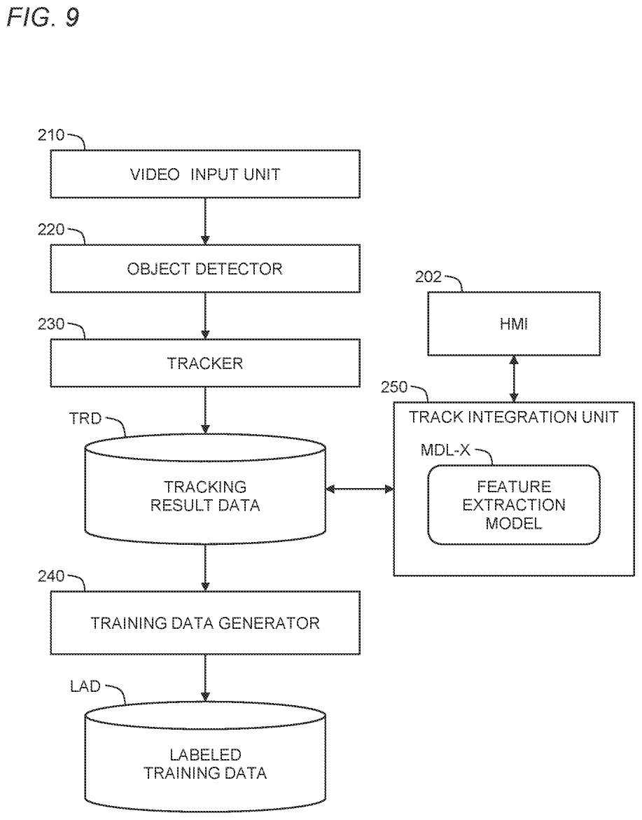

FIG. 9 is a block diagram showing a second example of a functional configuration of the training data generation system 200. The training data generation system 200 further includes a track integration unit 250 in addition to the functional blocks described in the above first example. The track integration unit 250 performs the track integration process. That is, the track integration unit 250 automatically detects the overlapping tracks based on the tracking result data TRD. If any overlapping tracks are detected, the track integration unit 250 automatically integrates the detected overlapping tracks into a single unified track.

More specifically, the track integration unit 250 includes a feature extraction model MDL-X. For example, the feature extraction model MDL-X is an existing object identification model. As another example, the feature extraction model MDL-X may be a pre-trained object identification model MDL. The track integration unit 250 inputs the sequence of images IMG into the feature extraction model MDL-X. The feature extraction model MDL-X extracts a feature amount of each moving object detected in the sequence of images IMG, and calculates a degree of similarity between the detected moving objects based on the extracted feature amounts. The degree of similarity is calculated based on a distance between the feature amounts in an embedded space. The degree of similarity becomes higher as the distance in the embedded space becomes smaller.

The track integration unit 250 acquires the above-described tracking result data TRD. Based on the tracking result data TRD and the degree of similarity between the detected moving objects, the track integration unit 250 checks whether or not there are overlapping tracks. When the degree of similarity between a first moving object of a first track and a second moving object of a second track is higher than a threshold, the track integration unit 250 determines that the first moving object and the second moving object are identical and the first track and the second track are the overlapping tracks. In this case, the track integration unit 250 integrates the first track and the second track into a single unified track.

After the track integration process is completed, the track integration unit 250 may present the result of the track integration process to a human checker through the HMI 202. For example, the track integration unit 250 presents the sequence of images IMG and the track TRi modified by the track integration process to the human checker. For example, the track integration unit 250 may display the result of the track integration process on the display of the HMI 202.

The human checker checks the result of the track integration process. For example, the human checker checks whether or not the automatically-detected overlapping tracks really are overlapping tracks given to the same moving object. As another example, the human checker checks whether or not the detected overlapping tracks are correctly integrated into a single unified track. The human checker uses the HMI 202 to modify the result of the track integration process as necessary.

After checking the result of the track integration process, the human checker approves the result of the track integration process. In response to that, the result of the track integration process is reflected in the tracking result data TRD. In other words, the result of the track integration process is fed-back to the tracking result data TRD. After that, the training data generator 240 generates the labeled training data LAD based on the sequence of images IMG and the tracking result data TRD. Therefore, the result of the track integration process is reflected in the labeled training data LAD.

According to the second example, as described above, the overlapping tracks regarding the same moving object are automatically detected and integrated into a single unified track. Since the overlapping tracks disappear, the deterioration of accuracy of the model training is suppressed. Furthermore, the human work is reduced. Even when the human checker checks the result of the track integration process, the human work is greatly reduced as compared with a case where the human checker manually performs the track integration process.

### 2-3. Third Example

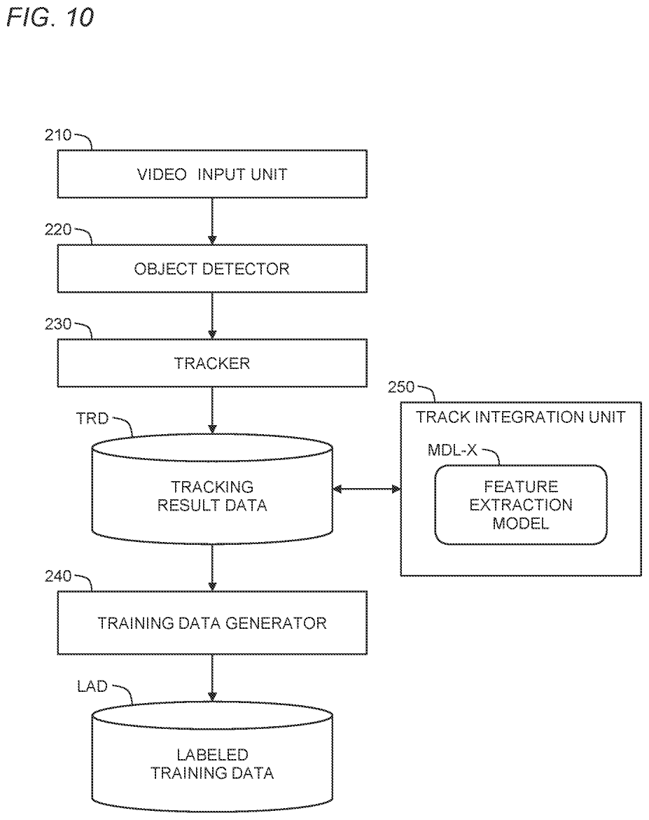

FIG. 10 is a block diagram showing a third example of a functional configuration of the training data generation system 200. In the third example, the human checker does not check the result of the track integration process. The result of the track integration process is directly reflected in the tracking result data TRD without through the human check. That is, the result of the track integration process is reflected in the labeled training data LAD without through the human check.

According to the third example, the human work is further reduced as compared with the above-described second example. It should be noted that an error of the tracking integration process are allowable to some extent.

### 3. Model Training System

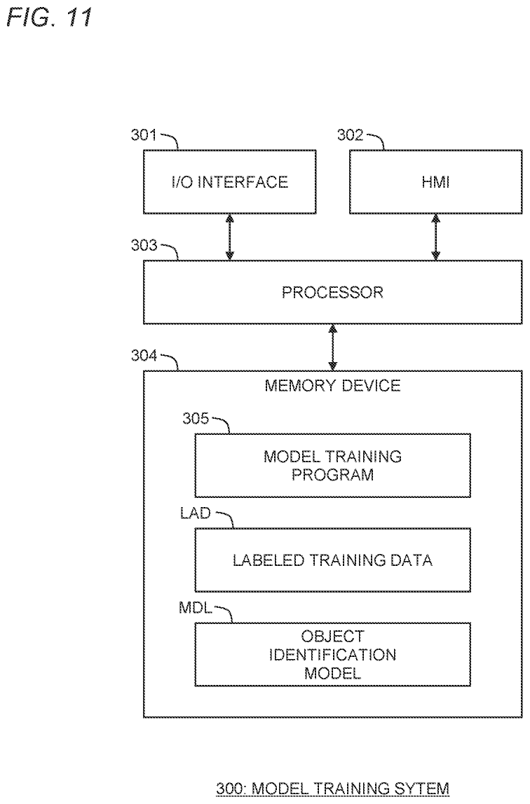

FIG. 11 is a block diagram showing a configuration example of the model training system 300 according to the present embodiment. The model training system 300 includes an I/O (Input/Output) interface 301, an HMI 302, one or more processors 303 (hereinafter simply referred to as a processor 303), and one or more memory devices 304 (hereinafter simply referred to as a memory device 304).

The I/O interface 301 receives a variety of data from the outside and outputs a variety of data to the outside. For example, the I/O interface 301 includes a network interface controller (NIC).

The HMI 302 is an interface for providing information to a user and receiving information from the user. More specifically, the HMI 302 includes an input device and an output device. Examples of the input device include a touch panel, a key board, and the like. Examples of the output device include a display, and the like.

The processor 303 executes a variety of processing. For example, the processor 303 includes a CPU. The memory device 304 stores a variety of information necessary for the processing. Examples of the memory device 304 include a volatile memory, a non-volatile memory, an HDD, an SSD, and the like.

The processor 303 executes a model training process. In the model training process, the processor 303 acquires the labeled training data LAD via the I/O interface 301. The labeled training data LAD are stored in the memory device 304. The processor 303 trains the object identification model MDL by using the labeled training data LAD. The object identification model MDL after the training is stored in the memory device 304. Moreover, the processor 303 outputs the object identification model MDL after the training to the object identification system 400 (see FIG. 2) via the I/O interface 301.

A model training program 305 is a computer program executed by the processor 303 to perform the model training process. The model training program 305 is stored in the memory device 304. The model training program 305 may be recorded on a non-transitory computer-readable recording medium. The model training program 305 may be provided via a network. The model training process is achieved by a cooperation of the processor 303 executing the model training program 305 and the memory device 304.

Hereinafter, several examples of the model training process will be described.

### 3-1. First Example

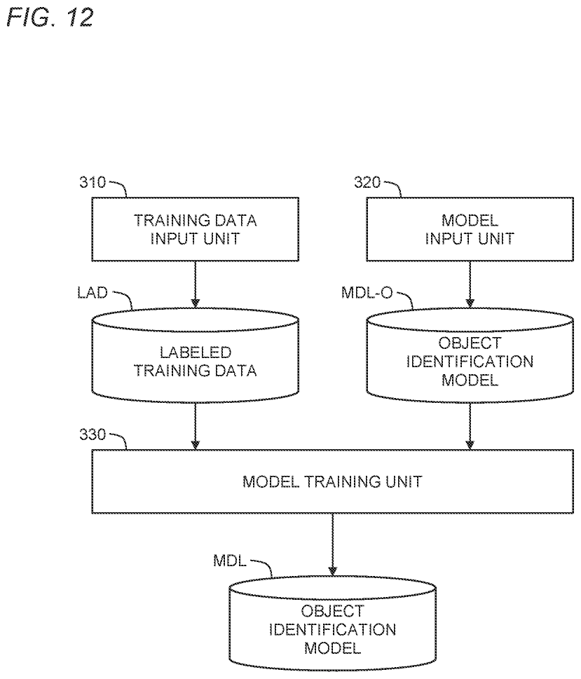

FIG. 12 is a block diagram showing a first example of a functional configuration of the model training system 300. The model training system 300 includes, as functional blocks, a training data input unit 310, a model input unit 320, and a model training unit 330.

The training data input unit 310 acquires the labeled training data LAD via the I/O interface 301 or from the memory device 304.

The model input unit 320 acquires an object identification model MDL-O via the I/O interface 301 or from the memory device 304. The object identification model MDL-O is an object identification model before the training.

The model training unit 330 trains the object identification model MDL-O based on the labeled training data LAD. In other words, the model training unit 330 trains the object identification model MDL-O by using the labeled training data LAD. Here, a supervised learning or a semi-supervised learning is used for training the object identification model MDL-O. As a result, the trained object identification model MDL is acquired.

### 3-2. Second Example

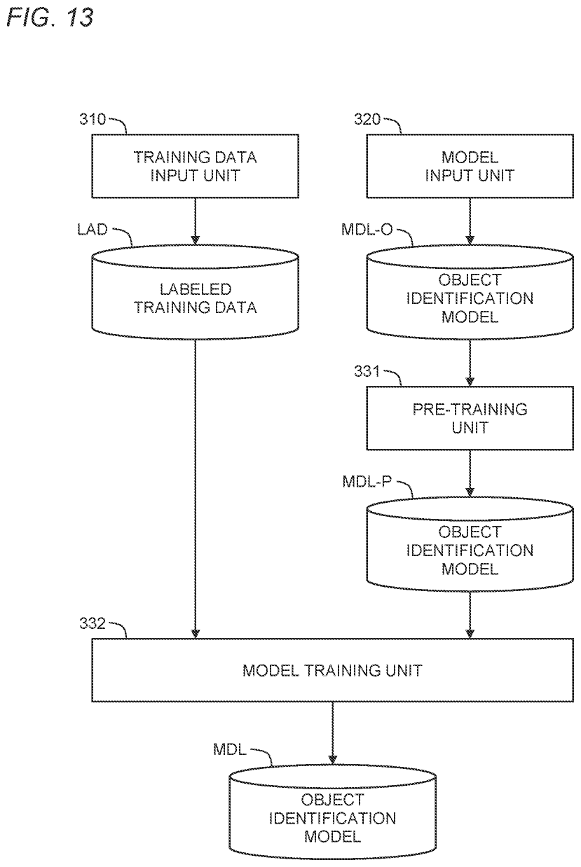

FIG. 13 is a block diagram showing a second example of a functional configuration of the model training system 300. The model training system 300 includes, as functional blocks, the training data input unit 310, the model input unit 320, a pre-training unit 331, and a model training unit 332.

The pre-training unit 331 pre-trains the object identification model MDL-O by using existing data set. For example, the pre-training unit 331 pre-trains the object identification model MDL-O based on a self-supervised learning. The self-supervised learning does not need labeled training data but only requires bounding box. As a result of the pre-training, an object identification model MDL-P is acquired.

It should be noted that the pre-trained object identification model MDL-P may be used as the feature extraction model MDL-X in the track integration process described above (see FIGS. 9 and 10).

The model training unit 332 further trains the pre-trained object identification model MDL-P based on the labeled training data LAD. Here, a supervised learning or a semi-supervised learning is used for training the pre-trained object identification model MDL-P. As a result, the high-accuracy object identification model MDL is acquired.

What is claimed is:

1. A model training method for training an object identification model that is based on machine learning,
the method comprising:
acquiring labeled training data where a track is given as a label to a sequence of images, wherein the track is information representing a time series of a same moving object in the sequence of images and is automatically obtained by a tracker that tracks the same moving object in the sequence of images; and
training the object identification model based on the labeled training data.

2. The model training method according to claim 1, further comprising a training data generation process that includes:
detecting a moving object in the sequence of images;
tracking the same moving object in the sequence of images by using the tracker to automatically obtain the track; and
generating the labeled training data by giving the track as the label to the sequence of images.

3. The model training method according to claim 2, wherein
a bounding box represents a location of the detected moving object in the sequence of images, and
the tracker tracks the same moving object based on a movement of the bounding box, without performing feature extraction.

4. The model training method according to claim 3, wherein
the tracker associates multiple bounding boxes representing the same moving object in the sequence of images with each other, and
the track is information indicating the multiple bounding boxes representing the same moving object in the sequence of images.

5. The model training method according to claim 2, wherein
the training data generation process further includes a track integration process that includes:
detecting two or more different tracks that are given to the same moving object; and
integrating the two or more different tracks into a single track.

6. The model training method according to claim 5, wherein
the track integration process includes:
inputting the sequence of images into a feature extraction model to extract a feature amount of each moving object detected in the sequence of images and calculate a degree of similarity between moving objects based on the extracted feature amount; and
when the degree of similarity between a first moving object of a first track and a second moving object of a second track is higher than a threshold, determining that the first moving object and the second moving object are identical and integrating the first track and the second track into a single track.

7. The model training method according to claim 5, wherein
a result of the track integration process is reflected in the labeled training data without through a human check.

8. The model training method according to claim 1, wherein
the object identification model is a human re-identification model.

9. A model training system that trains an object identification model that is based on machine learning,
the model training system comprising one or more processors configured to:
acquire labeled training data where a track is given as a label to a sequence of images, wherein the track is information representing a time series of a same moving object in the sequence of images and is automatically obtained by a tracker that tracks the same moving object in the sequence of images; and
train the object identification model based on the labeled training data.
